(19) United States
(12) Patent Application Publication
(10) Pub. No.: US 2013/0119729 A1
(43) Pub. Date: May 16, 2013

(54) VEHICLE SEAT

(71) Applicant: Faurecia Autositze GmbH, Stadthagen (DE)

(72) Inventor: Christian Neyrinck, Stradthagen (DE)

(73) Assignee: Faurecia Autositze GmbH, Stadthagen (DE)

(21) Appl. No.: 13/666,041

(22) Filed: Nov. 1, 2012

(30) Foreign Application Priority Data
Nov. 9, 2011 (DE) 102011117927.9

(51) Int. Cl. B60N 2/44

(52) U.S. Cl. CPC B60N 2/448
USPC 297/217.3

(57) ABSTRACT

A vehicle seat has a backrest and a back massage device provided at the backrest. The massage device exhibits electrically and/or mechanically operated pressure elements for exerting pressure onto the back of an occupant. The pressure elements are arranged along the longitudinal direction of the backrest between the seat area and the head area at different heights with pressure elements located nearer the seat (lower pressure elements) provided essentially in the area of the lumbar vertebrae of the backrest and pressure elements located above them (upper pressure elements). In the area of at least one of the upper pressure elements, the backrest is designed such that when at least operating the at least one upper pressure element, a force is exerted onto an occupant perpendicular to the surface of the back rest, said force being increased in this area compared to the area of the lower pressure element.

The invention relates to a motor vehicle seat with a backrest and massage equipment arranged thereon according to the main subject of Patent claim 1.

When massaging the back of a user of a motor vehicle seat, it should normally be possible to massage all parts of the back of vehicle occupants, especially the lower back area around the vertebrae, and the upper region between the shoulders and shoulder blades. For this purpose, mechanical or pneumatic pressure elements are provided along the longitudinal extension of the backrest, which can exert pressure on the back and thus stimulate the corresponding parts of the back in a massaging fashion.

For example, it is known from CN 1989921 to use mechanical massage rollers as pressure elements, which adjust their position to the outline of the back and allow an essentially homogeneous contact with the back. EP 0 270 69 9 describes a pneumatically operated massage system, where several elongated air chambers are provided as pressure elements that are integrated in the seat and are oriented transverse to the direction of travel. The shape of the backrest is adapted to the curvature of the spine, such that the pressure elements can exert their action of force optimally onto the area to be massaged.

Usually, the pressure exerted by the back of the occupant on the seat is not distributed evenly across the length of the backrest, such that with the known devices an occupant feels a smaller massaging effect in the shoulder area than in the area of the lumbar vertebrae or pelvis.

It is, therefore, the object of the present invention to create a motor vehicle seat of the aforementioned kind in which a subjectively more even pressure distribution along the back is generated from the perspective of the vehicle occupant.

This objective is achieved by a vehicle seat with the features of Patent claim 1. Additional advantageous embodiments are set forth in the dependent claims.

According to the invention, it is provided that the force originating in the pressure elements is greater perpendicular to the surface of the backrest in the upper area of the backrest, i.e., in the area of the shoulders that is opposite the vehicle occupant, than the force of one or more pressure elements in the lower part of the backrest.

This can be achieved in different ways.

The pressure elements, which are preferably formed pneumatically like a bubble, may have different strokes perpendicular to the padded surface of the backrest, with a correspondingly larger stroke provided in the upper area. Furthermore, the pressure elements can be subjected to different forces, more for the upper than the lower. In addition, additional pressure elements can be provided in the area of the upper pressure elements. Alternatively or in addition, the upper pressure elements can be subjected to a greater pressure than the lower pressure elements. It is also conceivable to design the support areas of the backrest that support the pressure elements on the backrest with different hardnesses. It can be provided that the pressure elements in the upper area of the backrest are supported with stiffer or less flexible materials than the ones in the lower area. Finally, the pressure elements may be embedded at different depths in the seat cushion, in the upper area less deep than in the lower area. The result is that with the same load of the pressure elements, the pressing force onto the occupant of the vehicle is lower in the upper area than in the lower area of the backrest.

Preferably, the pressure elements along the backrest are arranged symmetrically around the spine of the occupant, i.e., symmetrically to a plane or line of symmetry of the backrest.

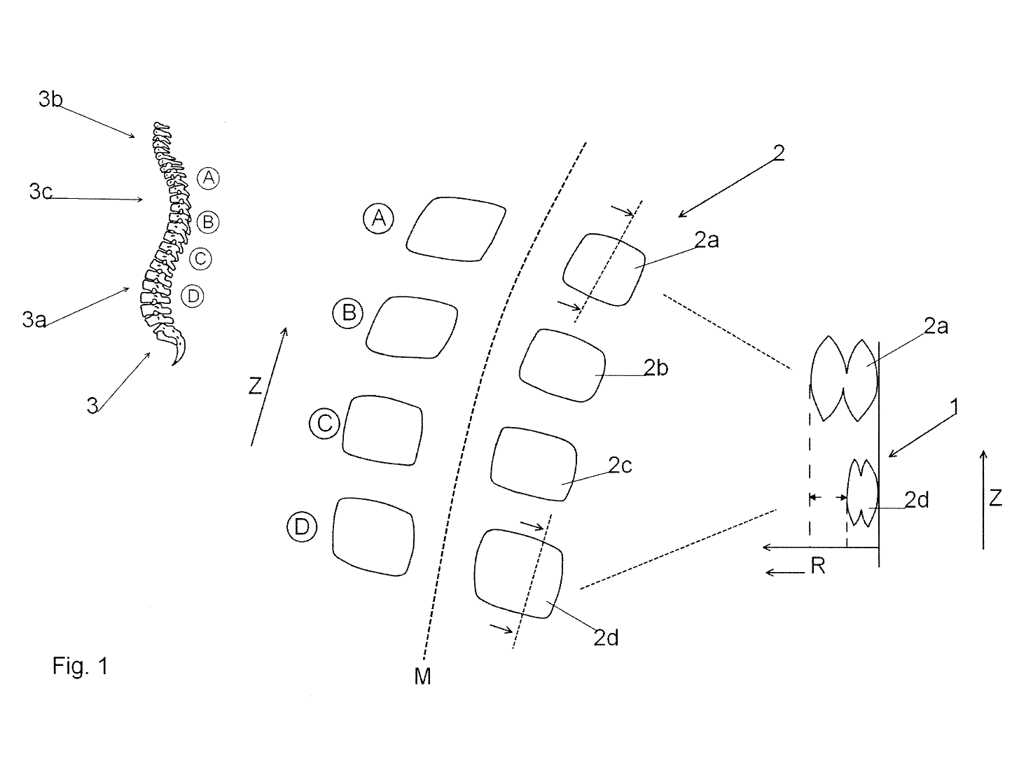

The invention will be described in greater detail below based on the exemplary embodiments shown in FIGS. 1 to 6.

FIG. 1 shows the schematic arrangement of the pressure elements according to a first embodiment of the vehicle seat according to the invention,

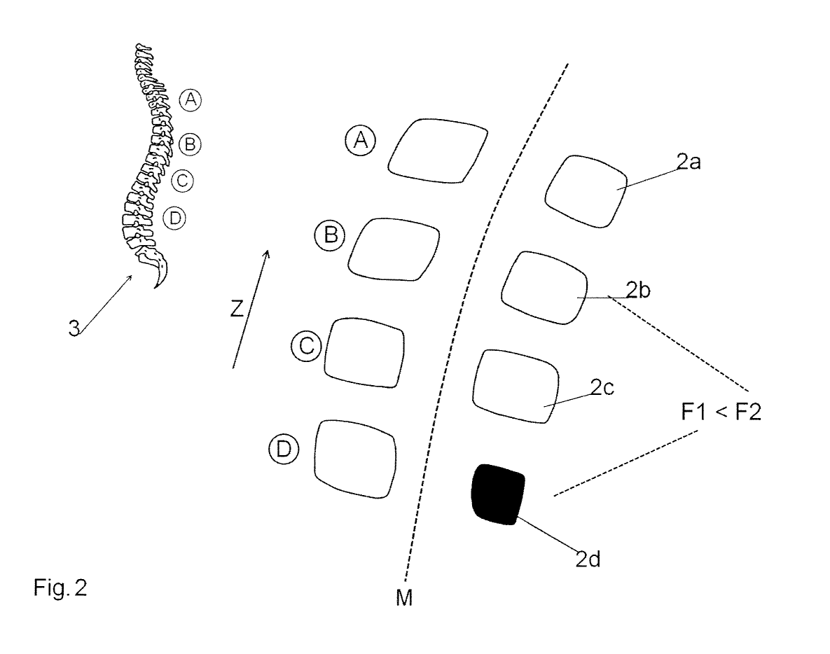

FIG. 2 shows the schematic arrangement of the pressure elements according to a second embodiment of the vehicle seat according to the invention,

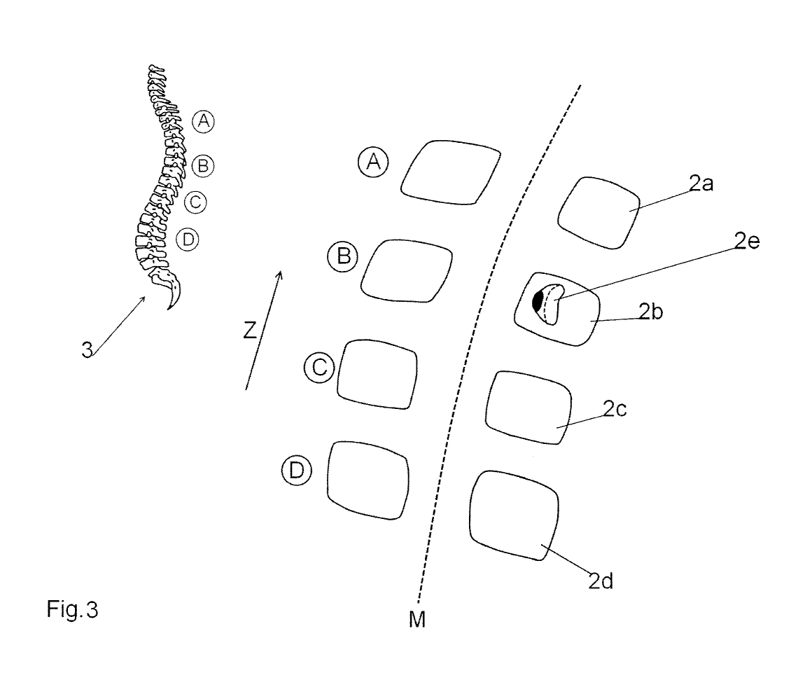

FIG. 3 shows the schematic arrangement of the pressure elements according to a third embodiment of the vehicle seat according to the invention,

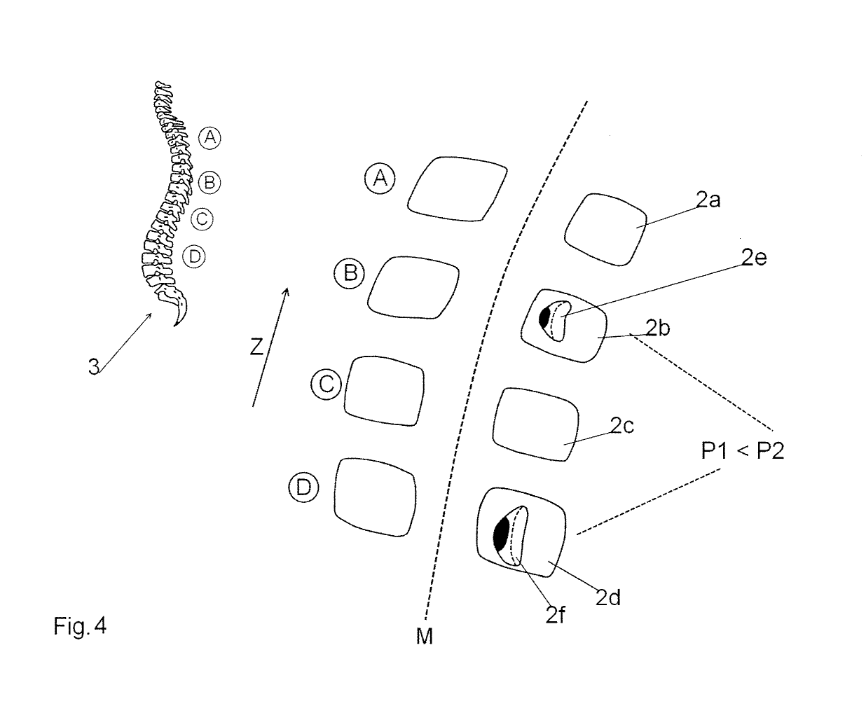

FIG. 4 shows the schematic arrangement of the pressure elements according to a fourth embodiment of the vehicle seat according to the invention,

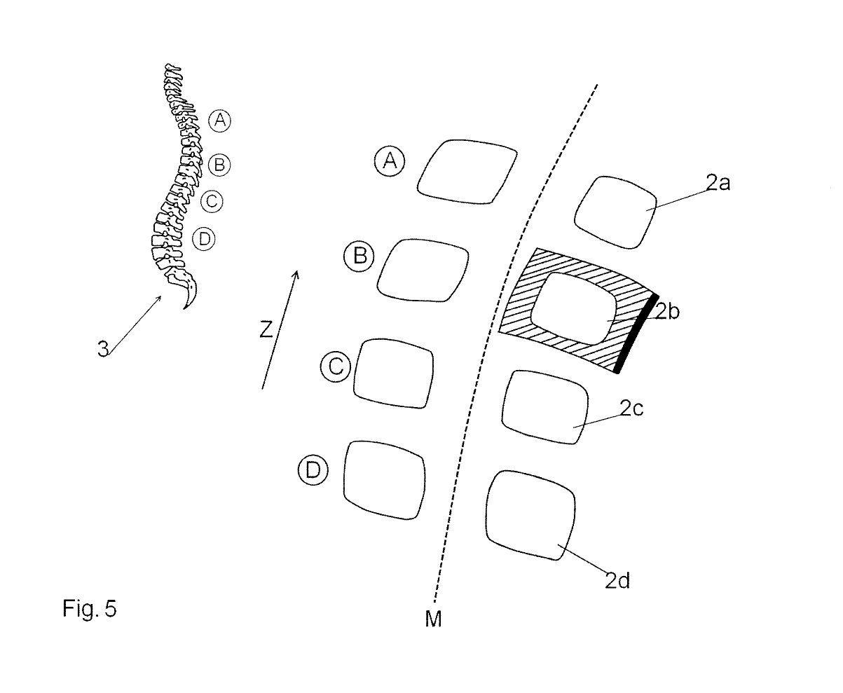

FIG. 5 shows the schematic arrangement of the pressure elements according to a fifth embodiment of the vehicle seat according to the invention,

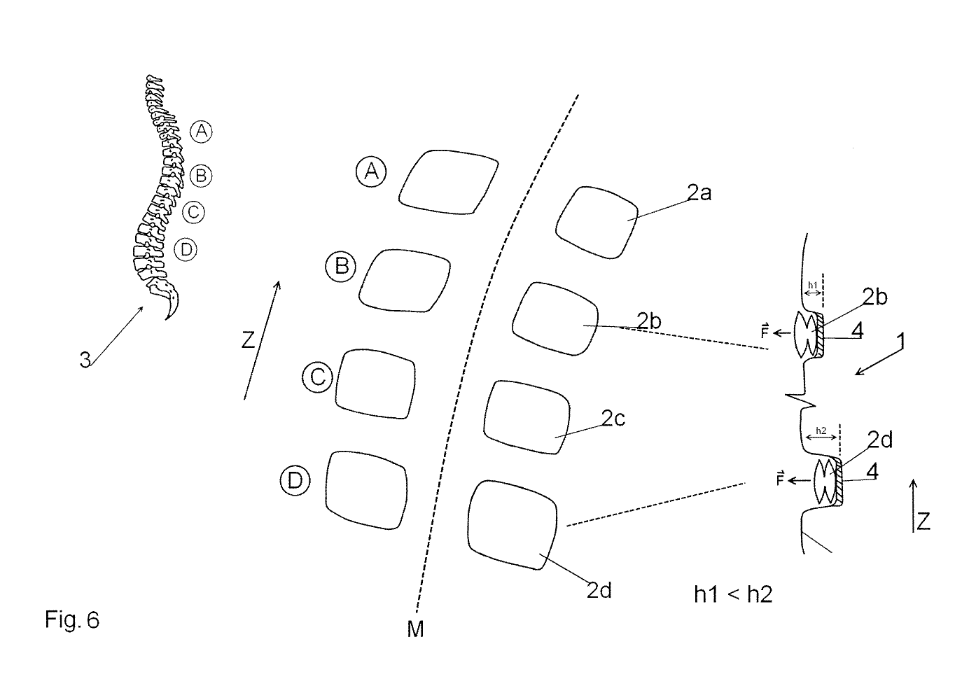

FIG. 6 shows the schematic arrangement of the pressure elements according to a sixth embodiment of the vehicle seat according to the invention.

The arrangement of the pressure elements 2a-2d, which form a massage device 2, shown schematically in FIGS. 1 to 6, serves as an example; of course other arrangements can be selected as well. Shown are pressure elements 2a-2d, which are arranged along the longitudinal extension Z of the backrest 1 and in the example shown, in pairs on either side of the center line M. The center line M forms a plane or line of symmetry of the backrest, such that the pressure elements 2a-2b can act evenly on both sides of the spine 3 of the occupant.

It is important that the pressure elements 2a-2d are arranged at different heights of the backrest. Here, height is to be understood relative to the longitudinal extension in the direction Z of the backrest 1, where “up” refers to the free area of the backrest 1 toward the headrest (not shown) and “down” to the portion of the backrest 1 facing seat section (not shown) of the backrest 1.

The spine 3 is shown in the drawings and is divided into areas A, B, C, D, with elements 2a, 2b, 2c, 2d, respectively, provided to these areas on the backrest 1. The pressure elements 2a-2d are each arranged such that they can act on the corresponding areas A-D.

In the side view of the spine 3, 3b refers to the section of the cervical vertebrae, 3c refers to the section of the thoracic vertebrae, i.e., the shoulder area and the upper part of the back, according to the sections A and B. 3a refers to the area of the lumbar vertebrae, according to sections C and D, approximately from the upper pelvis edge down to the coccyx.

If a vehicle occupant sits down in a seat, the pressure of the back against the backrest is typically lower in the upper area of the backrest in the areas A and B than in the areas C and D.

For this purpose, the invention proposes to design the pressure elements 2a-2d accordingly such that the pressing force is increased in the upper area.

In FIG. 1, pressure elements 2a, 2b, 2c, 2d are provided pairwise symmetrically to a center line M—as is the case in all subsequent Figures—and are presented in the drawing simplified as approximately square objects. In this embodiment, the pressure elements 2a and 2d are shown in sectional view and are each formed by an air bubble. When pressurized, the air bubble 2a exhibits a greater stroke, while the lower air bubble 2d exhibits a stroke that is shorter by Ds. Due to the longer stroke of the upper air bubble; the pressure of the upper pressure element 2a acting on the back of the occupant is increased in comparison to the lower pressure element 2d.

A similar result can be achieved when the lower pressure element 2d exhibits a smaller pressure surface, as shown in FIG. 2. In this manner, a lower force F1 is exercised in the lower area than in the upper area of the backrest 1, F2 with identical pressurization.

As shown in FIG. 3, it is also possible to provide additional pressure elements 2e in the upper area, which affect an additional force onto the back of an occupant. These can also be combined with an upper pressure element 2b or can be separate from said element.

As shown in FIG. 4, the pressure elements can vary greatly in size (in terms of the pneumatic filling volume), such that when pressurized with the same volume of air, the pressure P1 exerted in the lower area onto the occupant by a pressure element 2d is less than the pressure P2 in the area of the upper pressure element 2b.

As shown in FIGS. 5 and 6, it is also possible to use identical pressure elements at the top and at the bottom. The difference is that in the case of FIG. 5, the backrest is stiffened in the (upper) areas where the exertion of force is to be increased by providing enforcement 4 from the occupant's point of view behind the respective pressure element 2b. The pressure element 2b is supported by this enforcement and the backrest is less flexible and is stiffer in this area such that the pressure exerted by pressure element 2b essentially does not affect a deformation of the seat cushion towards the rear but instead an increased force in the direction of the vehicle occupant.

A similar example is shown in FIG. 6, except that in this example the support structure 4 is inserted at a different depth into the seat cushion 1a or against the driving direction into the area of the backrest, respectively. With cushion elements 2b and 2d, respectively, being of the same size, the pressure point of the upper, not as deeply inserted pressure element 2b, is closer to the surface of the seat cushion 1a than the pressure point of the pressure element 2d in the lower area. Because the seat cushion 1a is compressed more in the lower area than in the upper area, with this design the occupant has the subjective feeling that the exertion of forces during the massage is approximately the same at the top and at the bottom.

1. A motor vehicle seat with a backrest (1) and a massage device (2) provided at the backrest (1), for massaging the back, whereby the massage device (2) features electrically and/or mechanically operated pressure elements (2a, 2b, 2c, 2d) for exerting pressure onto the back of an occupant, said pressure elements being arranged along a longitudinal extension (Z) of the backrest defined between a seat area and a head area of the backrest (1) at different heights along said longitudinal direction (Z), with a first plurality of pressure elements (2c, 2d) provided essentially in the area of the lumbar vertebrae of the backrest (1) and a second plurality of pressure elements (2a, 2b) above them, characterized in that, the backrest (1) is designed in the area of at least one of the upper pressure elements (2a, 2b) such that at least when operating at least one of the second plurality of pressure element (2a, 2b), a force is exerted perpendicular to the surface of the backrest (1) onto an occupant, which force is increased in this area compared to the area of the first plurality of pressure elements (2c, 2d).

2. A motor vehicle seat with a backrest (1) and a massage device (2) provided at the backrest (1) for massaging the back, whereby the massage device (2) features electrically and/or mechanically operated pressure elements (2a, 2b, 2c, 2d) for exerting pressure onto the back of an occupant, said pressure elements being arranged along the longitudinal extension (Z) of the backrest (1) defined between a seat area and a head area of the backrest (1) at different heights along said longitudinal direction (z), with a first plurality of pressure elements (2c, 2d) provided essentially in the area of the lumbar vertebrae of the backrest (1) and a second plurality of pressure elements (2a, 2b) above them, in particular as set forth in claim 1, characterized in that, in comparison to the first plurality of pressure elements (2c, 2d), at least one of the second plurality of pressure elements (2a, 2b);
i) when operated exhibits a greater stroke at least in one direction (R) perpendicular to the cushion area of the backrest (1), and/or
ii) exhibits a greater expansion, in particular parallel to a cushion surface of the backrest (1), and/or
iii) can be operated with a stronger force and/or
iv) are inserted deeper into a support layer (1a) of the backrest that supports the pressure elements (2a, 2b, 2c 2d) towards the back, and/or
v) are supported stronger in a rear area on the side of the pressure elements (2a, 2b) that faces away from the seat area, and/or
vi) are supported by additional pressure elements.

3. The vehicle seat as set forth in claim 1, characterized in that at least some pressure elements (2a, 2b, 2c, 2d) are arranged at least in pairs symmetrically around the symmetry plane or line (M) extending in the longitudinal extension (Z) of the backrest 1.

4. The vehicle seat as set forth in claim 1, characterized in that the pressure elements are designed such that the force exerted onto a vehicle occupant can be adjusted.
